(19) United States
(12) Patent Application Publication
(10) Pub. No.: US 2008/0168619 A1
(43) Pub. Date: Jul. 17, 2008

(54) Process For Production of Aircraft Stops, and Aircraft Door Stops Made of Carbon Composite Material

(75) Inventors: Manuel Gonzalez, La Magdelaine Sur Tarn (FR); Gilles Garrigues, Mons (FR)

Correspondence Address: YOUNG & THOMPSON, 209 Madison Street, Suite 500, ALEXANDRIA, VA, 22314, US

(73) Assignee: LATECOERE, TOULOUSE (FR)

(21) Appl. No.: 11/994,999

(22) PCT Filed: Jul. 7, 2006
(86) PCT No.: PCT/FR2006/001660

§ 371 Date: Jan. 8, 2008

(30) Foreign Application Priority Data
Jul. 8, 2005 (FR) 0507295

(51) Int. Cl. E05F 5/00; B64C 1/14; B23P 11/00

(52) U.S. Cl. 16/82; 29/525.01

(57) ABSTRACT

In a process for the production of an aircraft stop by molding a composite material of resin and carbon fibers, a stack of pieces made of composite material, in which a metal piece will have been inserted, is draped by superposing layers of carbon fibers that are preimpregnated with resin, whereby the fibers are oriented so as to ensure maximum cohesion of the unit around the metal piece (4).

This invention relates to a process for the production of an aircraft stop that is at least partially made of composite material.

This invention also relates to an aircraft stop that is at least partially made of carbon composite material.

The aircraft doors consist of a structure that can accommodate mechanisms that make it possible to perform opening and closing maneuvers. The structure of the door is articulated around a piece called a “door arm” that is itself attached to the structure of the fuselage. The support of the door on the fuselage consists of an intermittent system and is performed through pieces called “stops” and is secured, on the one hand, to the door, and, on the other hand, opposite the fuselage.

It is known that these stops are made by machining, molding or stamping processes.

It is also known that the door stops are made of aluminum alloys or titanium alloys.

The disadvantage of metal solutions is specifically that they do not always meet the minimum weight restriction in an optimum manner.

The solutions based on composite materials starting from continuous carbon fibers offer much better performance levels, but the disadvantage of their application with the conventional processes is the high cost linked to their use.

One object of the invention is to provide an aircraft stop that combines the good behavior of the metal materials with the lightness of the composite material.

For this purpose, a known process for molding a part from composite material is used, of the type that consists in placing in a mold a stack of layers of fibers woven in a thermosetting or thermoplastic material and arranged in preferred directions of said fibers, and then in putting the mold under pressure.

However, the implementation of this process for the production of aircraft door stops poses a certain number of special problems because of the stresses such stops undergo. Actually, the forces that the stops have to absorb are on the order of 1.3 tons each time the door closes, which brings out very significant fatigue phenomena.

These problems will be solved, according to the invention, by a special arrangement of the carbon fibers that makes it possible to resist flexions induced by the force applied to the stop screw.

In contrast, it proves impossible in practice to screw the stop screw into a carbon piece, creating the necessity of installing a metal insert.

Securing this metal insert into a resin-based part also poses a problem that is difficult to solve, however.

The process according to this invention provides a solution to all of these problems.

The invention has as its object a process for the production of an aircraft stop that comprises a metal insert by molding a composite material of resin and carbon fibers, comprising at least one step that consists in draping a stack of pieces made by means of superposing carbon layers that are preimpregnated with resin, whereby the layers are oriented so as to ensure maximum cohesion of the unit around the metal insert.

The process can comprise the following steps:
First, a piece is made by draping, when flat, several coverings of carbon layers that are preimpregnated with resin, whereby this draping comprises a set of layers positioned longitudinally and layers that are separated into two flaps separated by a median part (step 1),
Then, said median part is wound around a metal insert that is provided with two shoulders (step 2),
Then, this insert is installed in the equipment by means of a positioning shaft (step 3),
Then, the first pair of flaps and then the second pair of flaps are folded down one after the other, (step 3)
Then, a reinforcement piece (step 4) and a cap (step 5) are installed under the piece,
And the entire unit is covered by folding down the two ends of the median part of the draping under the piece so that all of the constituent elements are covered in the draping of coverings of carbon layers that are preimpregnated with resin,
Then, three caps are installed under the piece.

The invention also has as its object an aircraft stop that comprises a metal insert that is manufactured by implementing a production process according to the invention.

The invention will be better understood owing to the following description given by way of nonlimiting example with reference to the accompanying drawings, in which:

FIG. 1 diagrammatically shows a top view of an aircraft door stop.

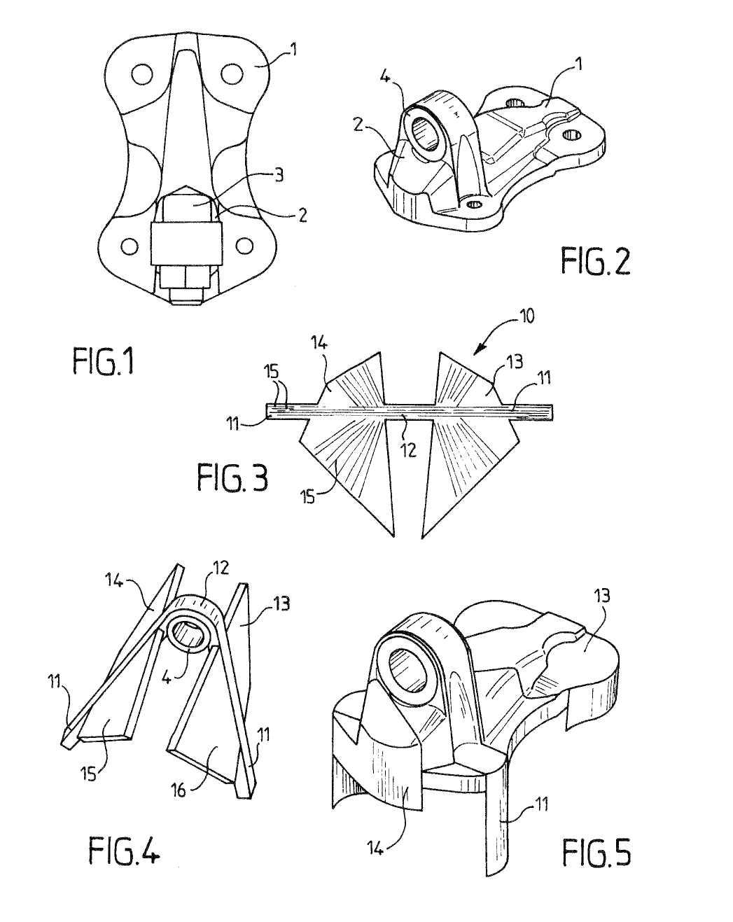

FIG. 2 diagrammatically shows a perspective view of the stop of FIG. 1, the stop screw having been removed.

FIG. 3 diagrammatically shows a view of the draping of carbon layers in a two-flap piece, corresponding to step 1 of a production process according to the invention.

FIG. 4 diagrammatically shows a view that illustrates step 2 of a production process according to the invention.

FIG. 5 diagrammatically shows a view that illustrates the beginning of step 3 of a production process according to the invention.

FIG. 6 diagrammatically shows a view that illustrates the end of step 3 of a production process according to the invention.

FIG. 7 diagrammatically shows a view that illustrates step 4 of a production process according to the invention.

FIG. 8 diagrammatically shows a view that illustrates step 5 of a production process according to the invention.

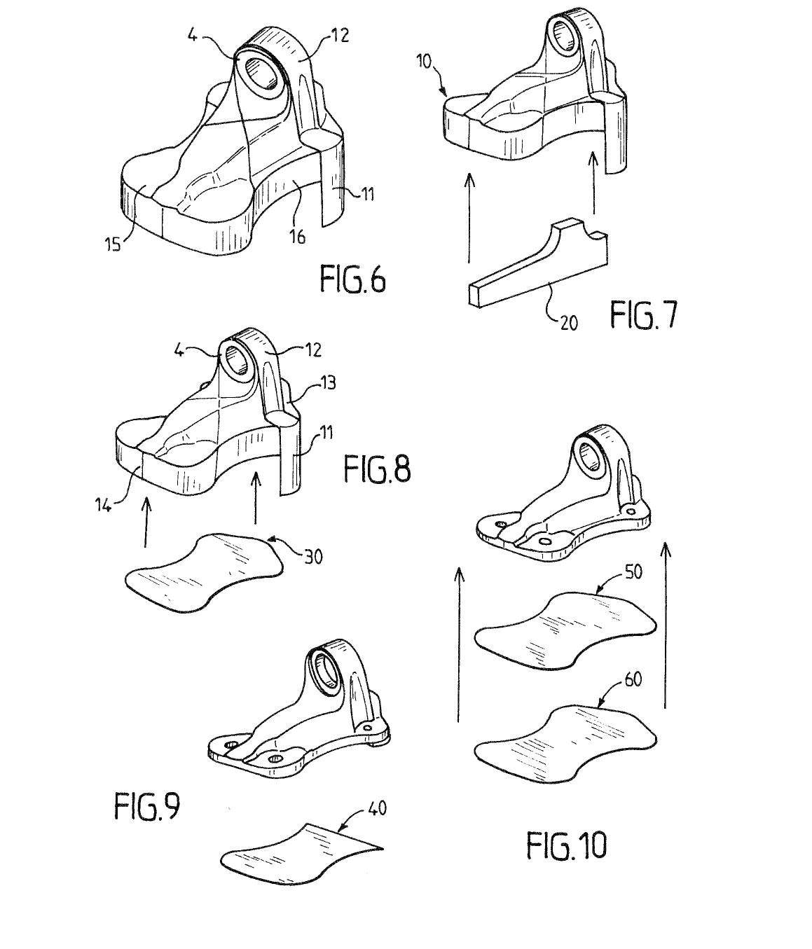

FIG. 9 diagrammatically shows a view that illustrates the beginning of step 6 of a production process according to the invention.

FIG. 10 diagrammatically shows a view that illustrates the end of step 6 of a production process according to the invention.

FIGS. 1 and 2 show an aircraft door stop that comprises a base 1 that is equipped with a square bracket 2 that supports a stop screw 3. The stop screw 3 has been removed in FIG. 2 so as to show a metal ring 4.

Actually, whereby the stop is made of composite material, it is not possible, taking into consideration the strength of the forces to be absorbed, to screw the stop screw into a plastic material: it is therefore necessary to install a metal insert, for example a metal ring 4.

And it is also necessary that this metal ring 4 be very firmly anchored in the material of the bracket 2. For this purpose, as will be explained in a detailed manner, this ring 4 has the shape of an insert that is equipped with at least two shoulders: one at each end.

FIG. 3 shows the first step in implementing the process.

At this step, a piece 10 that has the shape shown in FIG. 3 and that comprises a rectilinear part 11 and two side flaps 13 and 14 separated by a median part 12 is made by flat draping, several coverings of carbon layers. Carbon layers are arranged rectilinearly in the main part of the rectilinear part 11 of the piece 10 and are oriented obliquely in side flaps 13, 14, 15, and 16. The length of the median portion 12 of the rectilinear part 11 is equal to the distance that separates the two shoulders of the insert 4.

The piece 10 is made by draping a first piece that comprises parts shown by radiating segments and a second part with a larger surface area whose contour corresponds to the outside contour of the piece 10. The carbon layers are made by superposing folds of about 12 mm of width oriented along the angles shown in FIG. 3.

FIG. 4 shows the next step in implementing the process (step 2).

It is seen in this figure that the median part 12 of the rectilinear part 111 of the piece 10 that is made by draping carbon layers that are preimpregnated with resin is installed in a groove that is provided between the two shoulders of the insert 4.

After this installation, the piece 10 is bent and formed around the metal insert 4, in a V shape. The side flaps 13 and 14 are designed to be folded down on one another, while the front flaps 15 and 16 are intended to be folded down under the metal ring 4 to constitute a lower support surrounding the part of the metal ring 4 that is diametrically opposed to the median part 12. To make possible the bending of the belts that constitute the ends of the rectilinear part 11, a stack in the form of belts of lengths of between 150 and 215 mm is necessary.

FIG. 5 shows the third step after the side flaps 13 to 16 are folded down, in the draped conformation that allows the installation in baking equipment. The folding down of the points or flaps 13 and 14 on one another ensures the cohesion of the rear part, while the folding-down of the parts 15 and 16 under the metal insert 4 provides maximum cohesion of the unit including the metal insert 4.

After the installation in the baking equipment of the piece shown in FIG. 5, it is possible to subject this piece to high pressure so as to increase its resistance and cohesion around the metal insert 4.

Thus, the unit that is shown in FIG. 6, in which the points 13 and 14 are folded down on one another and also the points 15 and 16, is obtained.

The two ends of the rectilinear part 11 of the piece 10 are curved in a square angle toward the bottom and kept in reserve for the following steps.

FIG. 7 shows the fourth step in implementing a process according to the invention, in which a reinforcement piece 20 that is designed to be oriented along the longitudinal median plane of the unit shown in FIG. 6 is inserted from below and secured in place.

FIG. 8 shows the fifth step in implementing a process according to the invention, in which a base cap 30 that is designed to be oriented approximately horizontally is inserted from below and secured in place so as to block the lower part of the unit. The ends of the rectilinear part 11 of the piece 10 are then folded down under the cap 30 so as to surround the entire unit.

FIGS. 9 and 10 illustrate the sixth step of a process according to the invention that corresponds to the successive installation of pieces 40, 50, and 60 that constitute the cap of the stop.

After having produced the unit described with reference to FIGS. 3 to 10, the mold is closed on the thus produced unit, before temperature pressurization. This seventh step of pressurization and heating thus corresponds to what is called “composite forging” by one skilled in the art.

Using the process according to the invention, in particular a door stop that has excellent qualities of mechanical strength, fatigue strength, while being much lighter than a metal stop, which is highly advantageous given the large number of stops installed on an aircraft, is produced.

1. Process for the production of an aircraft stop that comprises a metal insert (4) by molding a composite material of resin and carbon fibers, consisting in draping a stack of pieces (10, 20, 30, 40, 50, 60) made by means of superposing carbon fiber layers that are preimpregnated with resin, whereby the layers are oriented so as to ensure maximum cohesion of the unit around the metal insert (4).

2. Process according to claim 1, wherein the stack of pieces of carbon fiber that is preimpregnated with resin accommodates a metal insert (4) that is designed to accommodate a stop screw (3).

3. Process according to claim 2, according to which the following stages are executed:
Stage 1: A piece (10) that comprises a set (11) of longitudinal layers and layers that are separated laterally into four flaps (13, 14, 15, 16) that are separated by a median part (12) is made by draping, when flat, several coverings of carbon layers (15) that are woven in the resin;
Stage 2: Said median part (12) is wound around a metal insert (4) that is equipped with two shoulders;
Stage 3: The insert as well as the piece (10) are installed in the molding equipment, and the flaps (13) and (14) are folded down on one another, and in the same way, the flaps (15) and (16) are folded down on another while preserving the two sides (11) of the piece (10) for later use;
Stages 4 and 5: The pieces (20) and the cap (30) are installed, then these two parts (11) preserved above are folded down to cover these two pieces;
Stage 6: The final step is to install three caps (40, 50, 60) to produce the entire completed stop;
Stage 7: The thus obtained piece is placed in a mold that is heated and that is pressurized.

4. Aircraft door stop that is produced by implementing a production process according to claim 1.
